(19) United States
(12) Patent Application Publication
(10) Pub. No.: US 2008/0136235 A1
(43) Pub. Date: Jun. 12, 2008

(54) Child automotive/aircraft/transportation harness restraint system

(76) Inventor: Mary L. Aaron, Denver, CO (US)

Correspondence Address: Mary L Aaron, 3226 Quitman Street, Denver, CO, 80212, US

(21) Appl. No.: 11/636,777

(22) Filed: Dec. 12, 2006

(51) Int. Cl. B60N 2/26

(52) U.S. Cl. 297/256.14

(57) ABSTRACT

A child's vehicular transportation add-on, adjustable harness restraint system, front and/or rear facing modes, consisting of flexible materials and hardware components as means for safely securing the child in the vehicle directly to the latches or seat/seat back frames or head rest/head rest posts including flexible materials to support the head, buttocks and legs in the rear facing mode and auxiliary tethers for attaching the system regardless of the number or location of the latch or latches or other fastening locations providing a weight/force reduction safety benefit.

### CROSS REFERENCE TO RELATED APPLICATIONS

Patents:

| D455,546 | Norman | April, 2002 |
|---|---|---|
| 4009808 | Carter | March, 1977 |
| 6,820,902 | Kim | November, 2004 |
| 6,857,700 | Eastman | February, 2005 |
| 6,916,066 | Sedlack | July, 2005 |
| 7,131,703 | Sheridan, et al | November, 2006 |
| 7,004,541 | Sedlack | February, 2006 |
| 4,674,800 | Ensign | June, 1987 |
| 6,767,058 | McClellan-Derrickson | July, 2004 |
| 4,976,494 | Polley | December, 1990 |
| 3,992,040 | Gannac | November, 1976 |
| 6,893,088 | Kassai, et al | May, 2005 |
| 6,877,809 | Yamazaki, et al | April, 2005 |
| 2,833,344 | Lucht | 1958 |
| 3,099,486 | Scott | 1963 |
| 3,115,364 | Berlin | 1963 |
| 4,428,514 | Elf | 1984 |
| 5,188,421 | Arseneault | 1993 |
| 5,292,175 | Artz | 1994 |
| 6,182,931 B1 | Richard | 2001 |
| 6,402,241 | Mazzotti | 2002 |

A child's vehicular transportation add-on, adjustable harness restraint system (CHRS), frontward (FF) and/or rearward facing (RF) modes, consisting of flexible materials and hardware components as means for safely securing the child to a vehicle utilizing the latches or seat/seat back frames or head rest/head rest posts including flexible materials that provide a variable length, padded, flat or concave body and head support and an add-on, affixed, adjustable buttocks, and leg support, including adjustment means, to the rearward facing mode and auxiliary tethers for attaching the system, regardless of the rearward number or latch or latches or other fastening locations.

The primary harness restraint system, the means utilized for attachment to the vehicle, rearward or frontward modes, consisting of nonflammable materials such as straps, tethers, webbing, fabrics and similar materials and hardware devices, components, such as latch hooks, span or length adjustors, “O” rings, restraint or release buckles, and/or other hardware as means for securing, safely, the harness system to the vehicle utilizing the vehicle tethers, latches, seat and/or seat back frames, and/or the seat back headrests and/or the headrest posts.

All materials, strapping, and hardware utilized in the restraint system have met current National Transportation Highway Safety Administration (NHTSA) child car seat/restraint standards.

Additionally, a “secondary means” add-on, adjoined child harness restraint system mode for securing various weights, sizes and ages of children including a minimum of three upper torso and pelvic restraint means, including harness bridging clips, consisting of the means for securing, safely, the add-on harness system to the primary vehicle restraint system, utilizing the same materials and permanent attachment means stated in paragraphs 0001, 0002, and 0003 above.

### BACKGROUND OF THE INVENTION

Presently the National Highway Traffic Safety Administration (NHTSA) Federal Motor Vehicle Standards 49CFR571.213 and 215 and various state laws dictate the requirements for restraining children of various relevant sizes, i.e., weight, height, and ages, in motor vehicles to withstand a deceleration velocity change of 48 MK/H.

Academy of Pediatrics has advised “over 30% of newborn infants are too small or physically not capable, or older children too large to fit safely in the existing, framed, child car seats”. Consequently, they are at greater risk.

Further, over 10,000,000 of the “rigid car seats” have been recalled because of injuries caused by safety problems or other design or fabrication compromises. Also, over 90% of available car seats are installed incorrectly creating safety hazards to children, because of the difficult installation requirements caused by the continued requirements to “use” existing, vehicle shoulder/lap belting for their securing purposes.

The installation of hard shell car seats is difficult when it consists of more than one component. These multiple unit car seats add unnecessary weight/force to the restraint system, again, compromising a child's safety. In effect, the child is not secured directly to the vehicle. Over 200,000 children were killed or injured, that were restrained in “car seats” in 2004 and 2005 according to NHTSA.

Also, because of the various vehicle seat configurations rigid shell seat systems are more difficult to install “correctly” and cannot be done due to physical limitations of many drivers. It should be noted the various state laws place all safety responsibility for the restrained children on the driver.

The subject child vehicular harness restraint system is an economic, safe means of restraining children to all seat or seat back shapes with the various latches, seat/seat back frames or head rest or head rest posts with the least amount of system weight.

The system is easily installed or removed from a vehicle and transported because of its minimal size, weight, and flexible compaction characteristics.

### BRIEF SUMMARY OF THE INVENTION

A child's vehicular transportation add-on, adjustable harness restraint system, frontward and rearward facing modes, consisting of flexible materials and hardware components as means for safely securing the child to the vehicle utilizing the latches or seat/seat back frames or head rest/head rest posts including flexible materials to provide flat or concave body and head support and add-on, affixed, adjustable buttocks and leg support to the rearward facing mode and auxiliary tethers for attaching the system, regardless of the number or location of the latch or latches or other fastening locations, providing a weight/force reduction safety benefit.

### BRIEF DESCRIPTION OF THE SEVERAL VIEWS OF THE DRAWINGS

FIGS. 1 and 1A: Illustrates a perspective view of the front (forward) facing, to the front of the vehicle, mode of the child vehicular transportation add-on, adjustable harness restraint system.

FIGS. 2 and 2A: Illustrates a perspective view of the rear (rearward) facing, to the rear of the vehicle, mode of the child vehicular transportation add-on adjustable harness restraint system with body support and add-on, affixed, adjustable buttocks, leg, and head support.

FIG. 3: Illustrates a perspective view of the primary Child Harness Restraint System (CHRS) restraint tethers, straps, vertical (1) and horizontal (2), excluding the tether latch hook hardware, and latch connection locations (3).

FIG. 4: Illustrates a respective view of the padded, flat or concave, child body support (4)

FIG. 5: Illustrates a perspective view of the secondary CHRS tether, strap system for restraining the child (5).

FIG. 6: Illustrates a perspective view of the add-on, adjustable, buttocks and leg support (6), added adjustment straps (7), child height adjustment slots (8) and additional latch tether, straps, connectors (9).

FIGS. 7 and 7A: Illustrates a right side elevation, view of the rear (rearward) facing, to the rear of the vehicle, mode of the vehicular, add-on, adjustable, child harness restraint system (5).

FIGS. 8 and 8A: Illustrates a right side elevation, view of the front (forward) facing, to the front of the vehicle, mode of the vehicular, add-on, adjustable, child harness restraint system, including the booster (10).

FIGS. 9 and 9A: Illustrates a plan view of typical adjustable length auxiliary tethers or strapping for attachments to latches, “O” rings, or to the head rest or head rest post connections (11) and latch hooks (12).

### DETAILED DESCRIPTION OF THE PREFERRED EMBODIMENT

In accordance with the present invention, a child vehicular transportation, add-on, adjustable, harness, facing frontward and/or rearward modes in a vehicle restraint system. Having a primary and secondary affixed, adjustable harness system including a flat or concave body support of various shapes including add-on, affixed, adjustable buttocks, leg, and/or head supports and adjustable tethers, straps and hardware necessary to attach the primary means to the vehicle and restraining a child within the secondary means including additional auxiliary vehicle attachment tethers/straps.

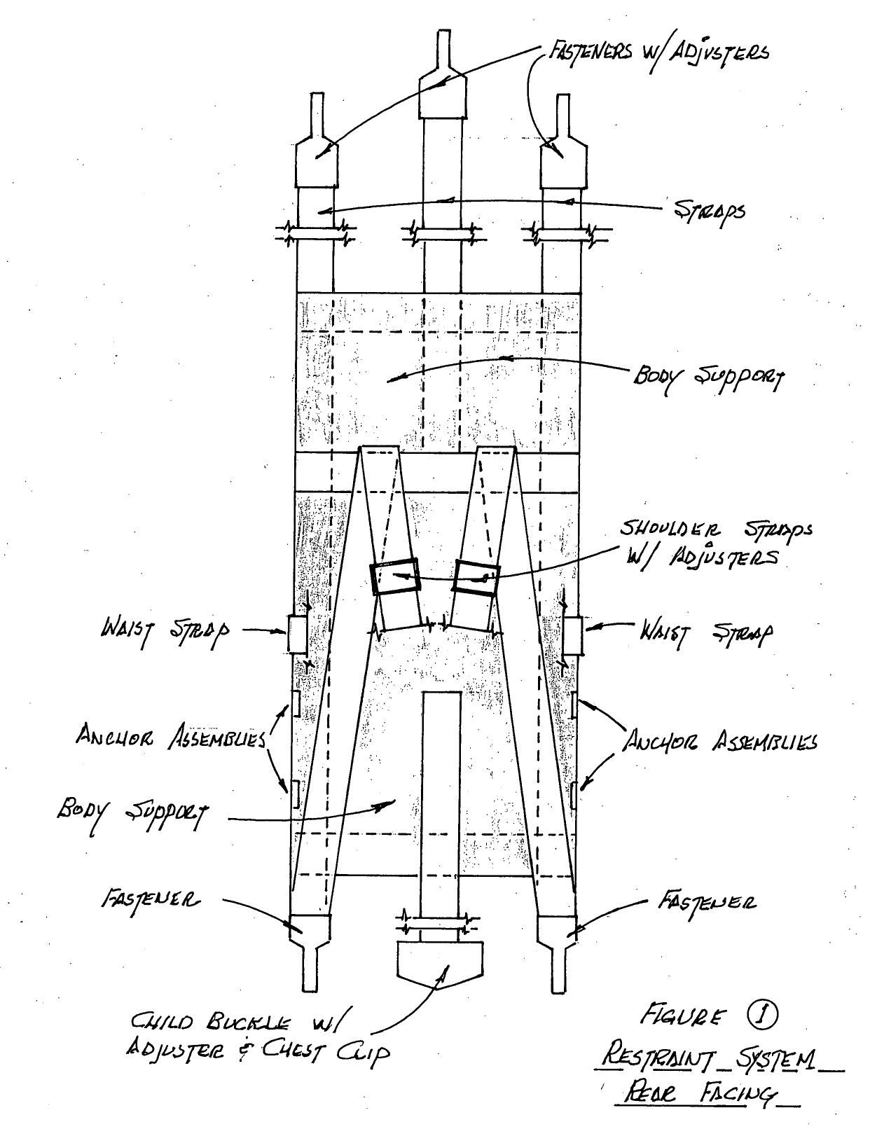

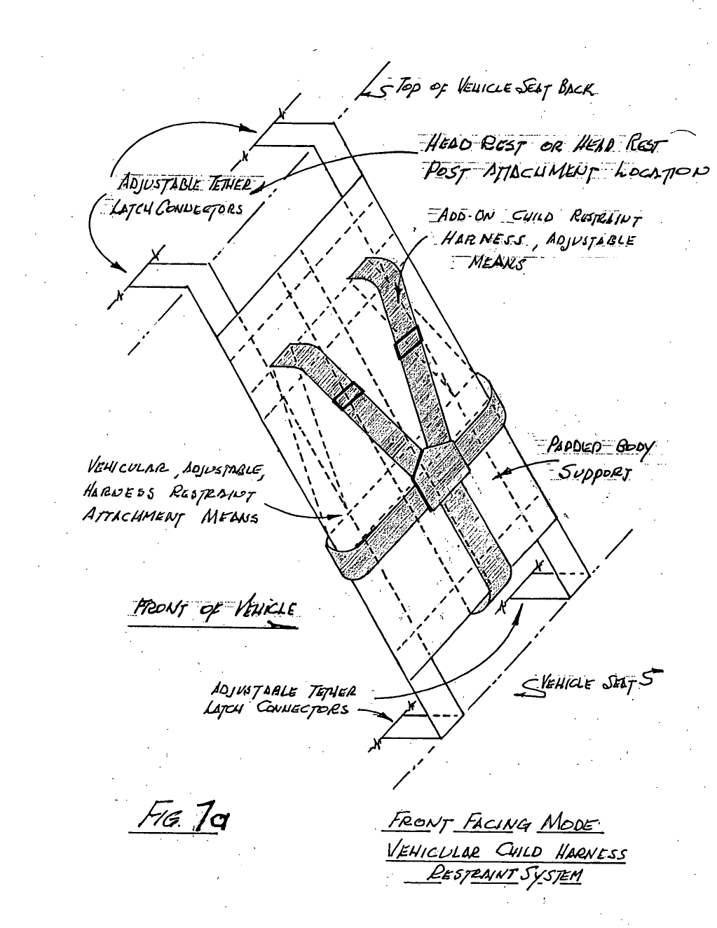

Referring to FIG. 1 the child vehicular, add-on, adjustable harness restraint system (CHRS) is illustrated in its forward facing mode. The CHRS has adjustable vertical tether straps (1) for affixing the CHRS to the vehicle (3). Horizontal/lateral straps (2) are permanently fastened via stitching, or otherwise, to the vertical straps for width control and the child body support (4) of non-flammable material coverings over foam padding and a polyurethane fabric reinforcement of various sizes and shapes.

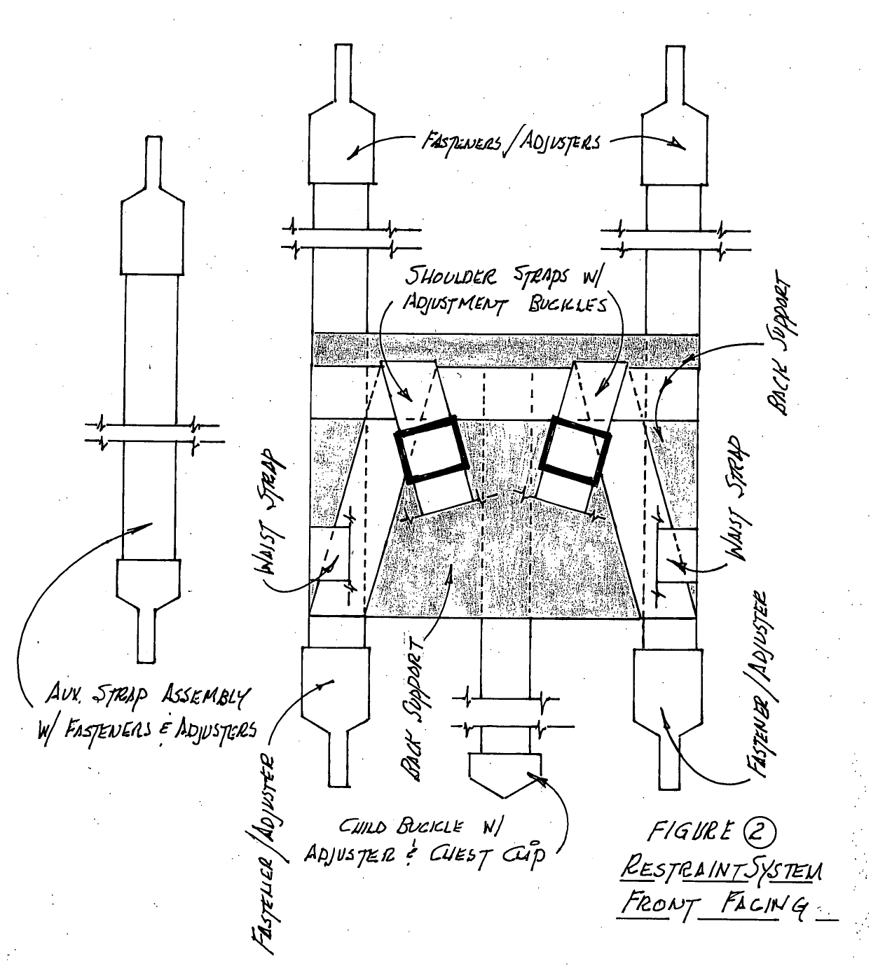

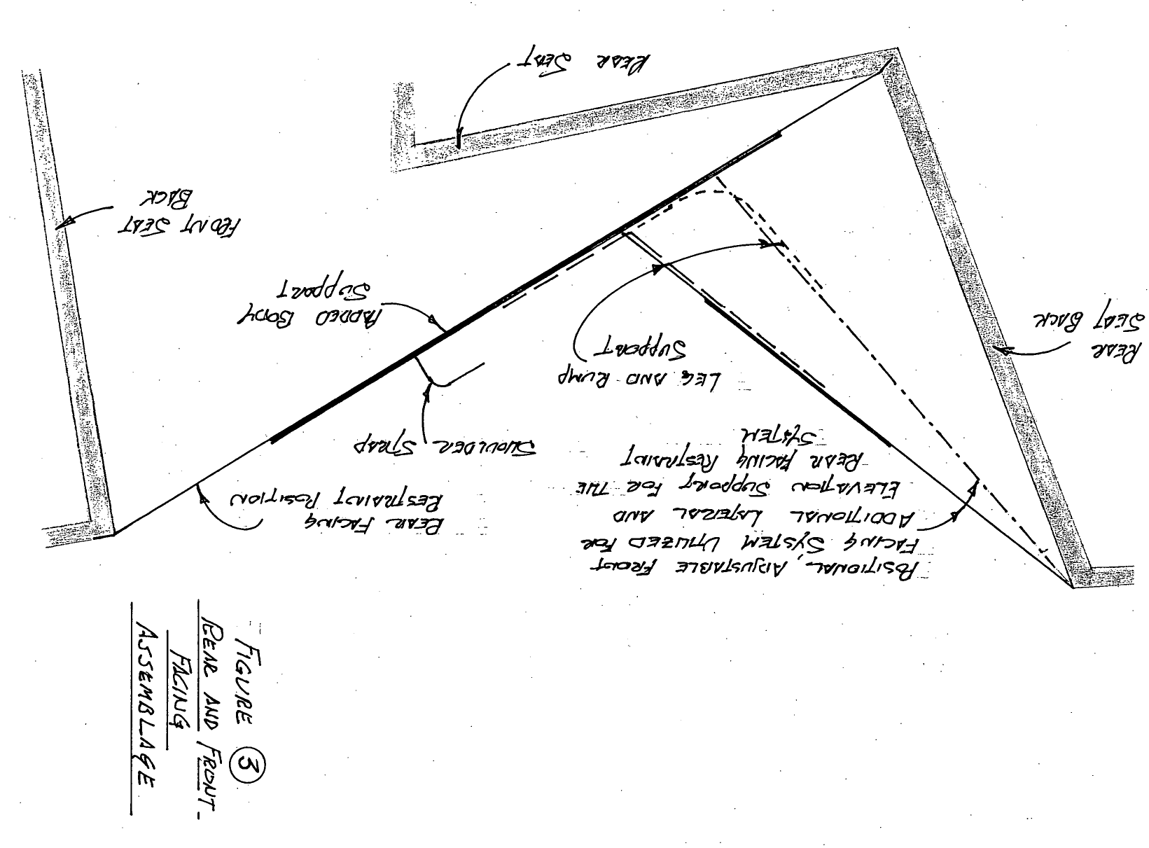

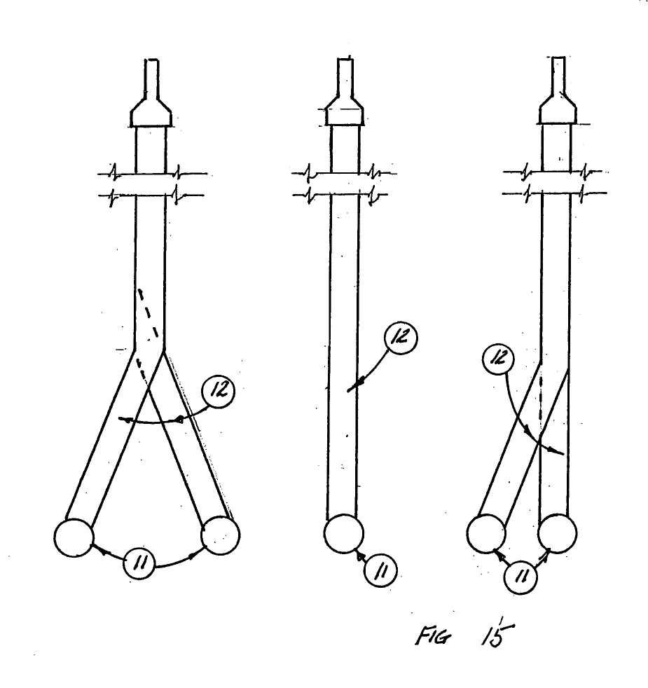

Referring to FIG. 2 the CHRS as illustrated in its rearward facing mode, CHRS/RF. The CHRS/RF has two major spanning, truss, rear to front tether straps utilizing the two primary adjustable tether straps (5), in a horizontal, front to rear mode, for spanning the variable distance between the bottom back of a rearward seat to the top of the forward seat back and attachments to the front head rests or head rest posts and/or to the front seat or seat back frame (13) of the vehicle. Auxiliary tethers (FIG. 9) (12) are affixed to the two primary tethers (1), for latch attachments behind the rearward seat.

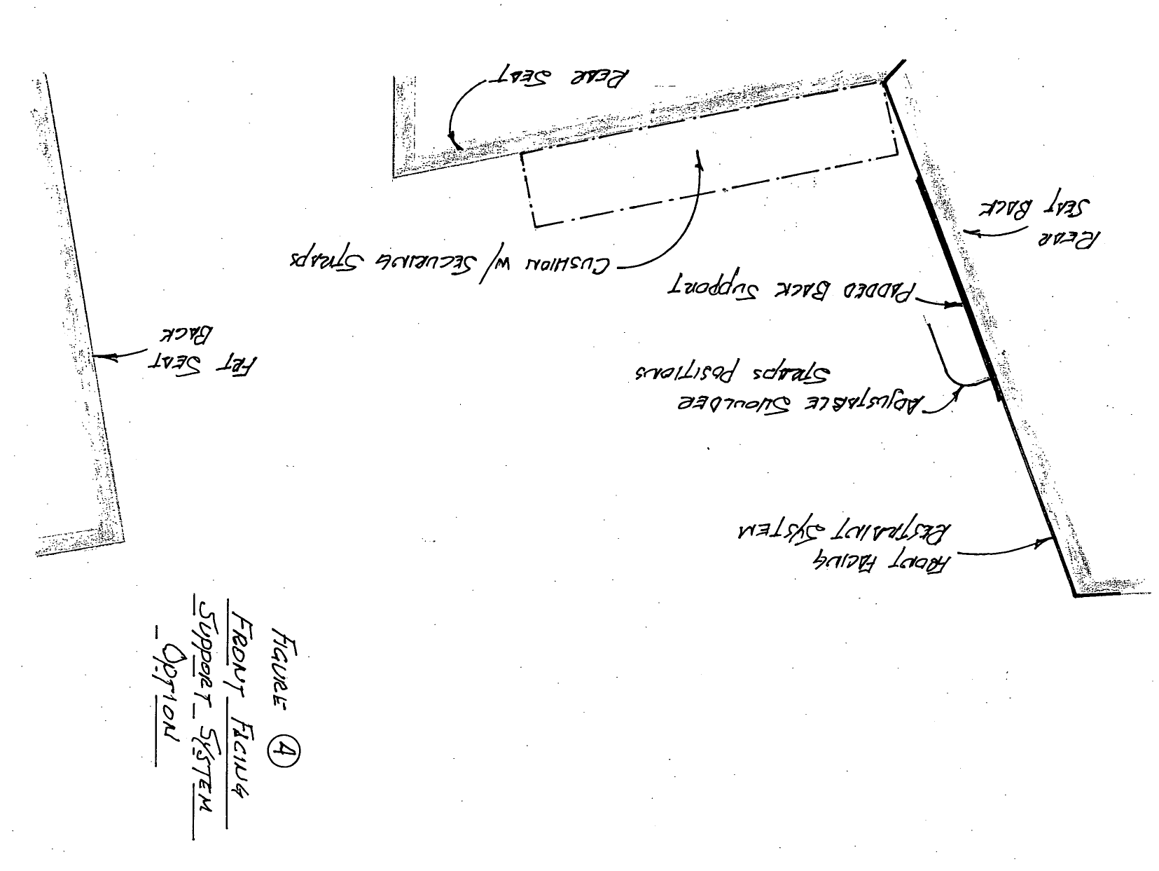

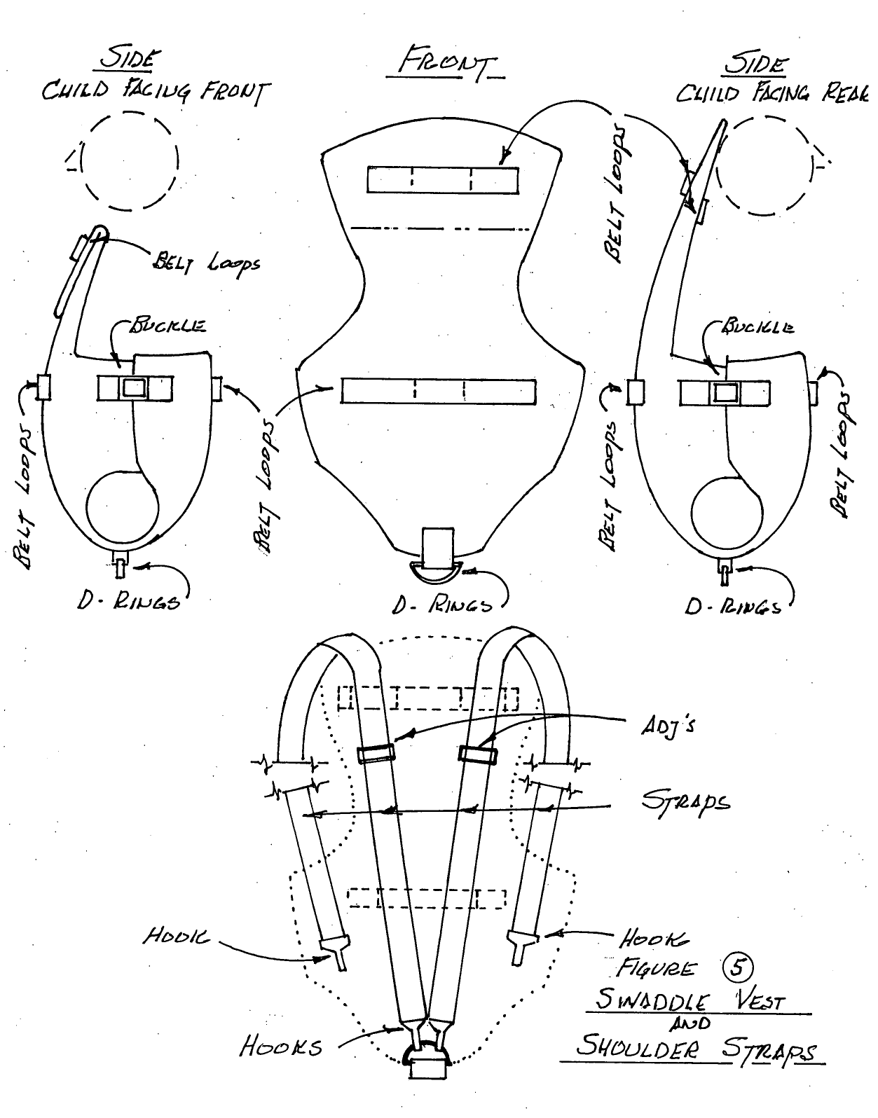

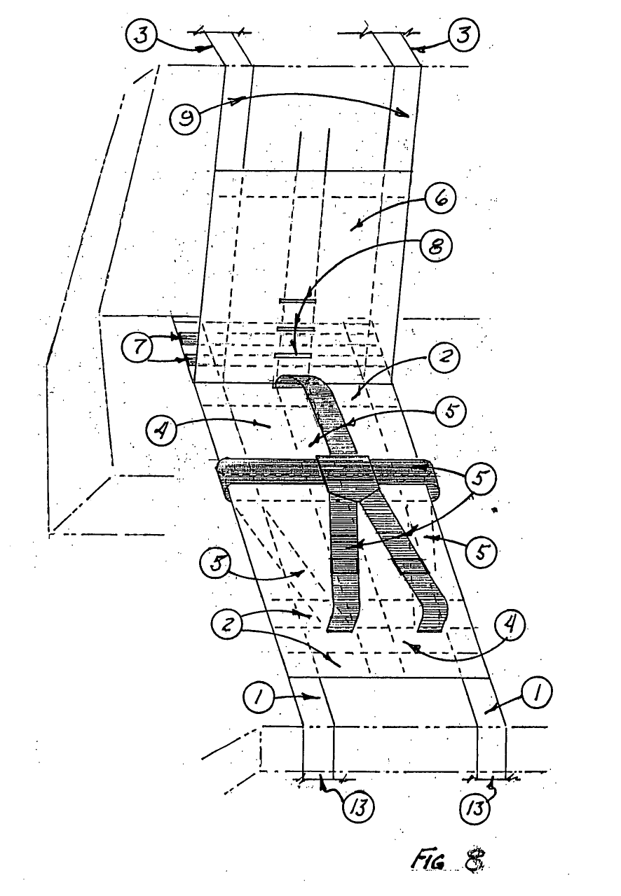

Referring to FIG. 3 to the primary structure as depicted and described in FIG. 1 is added a secondary CHRS attached system (FIG. 5) for restraining a child including strapping and child restraint (5) permanently affixed by stitching, or other means providing adjustable, upper torso and pelvic restraint means.

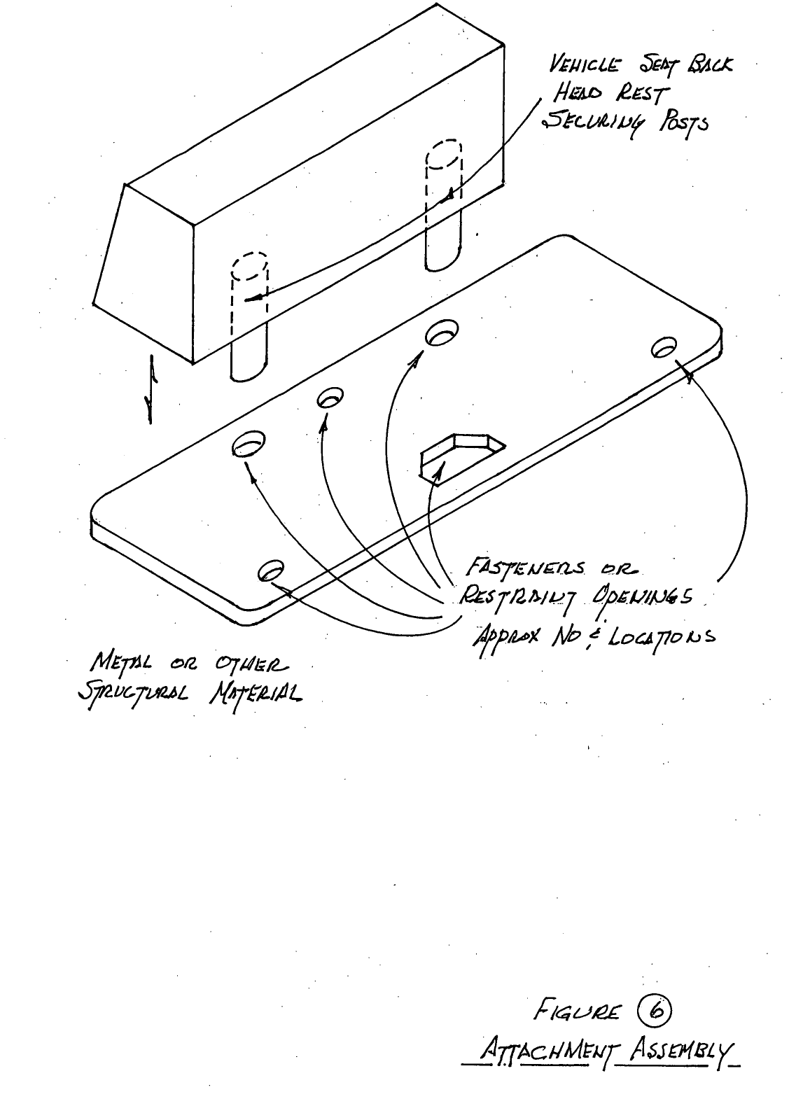

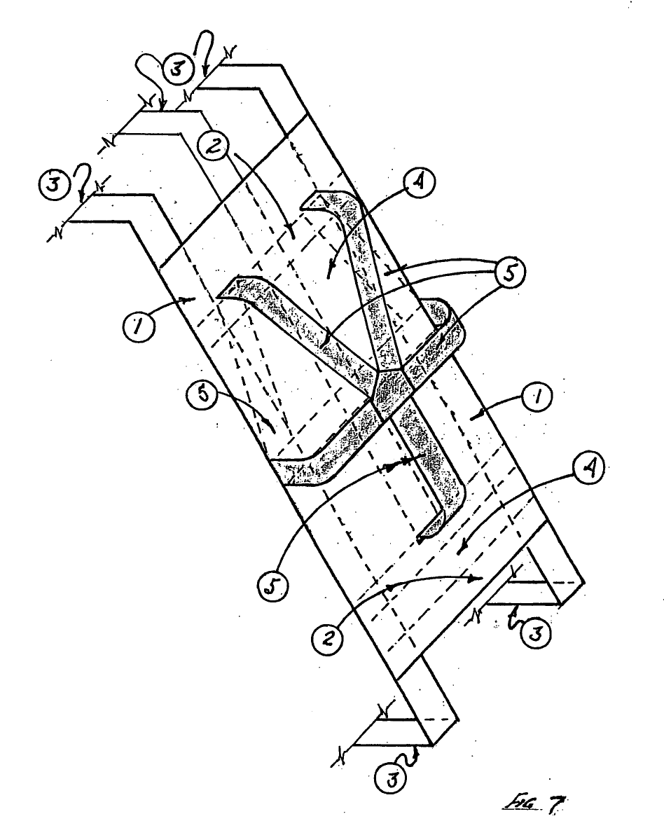

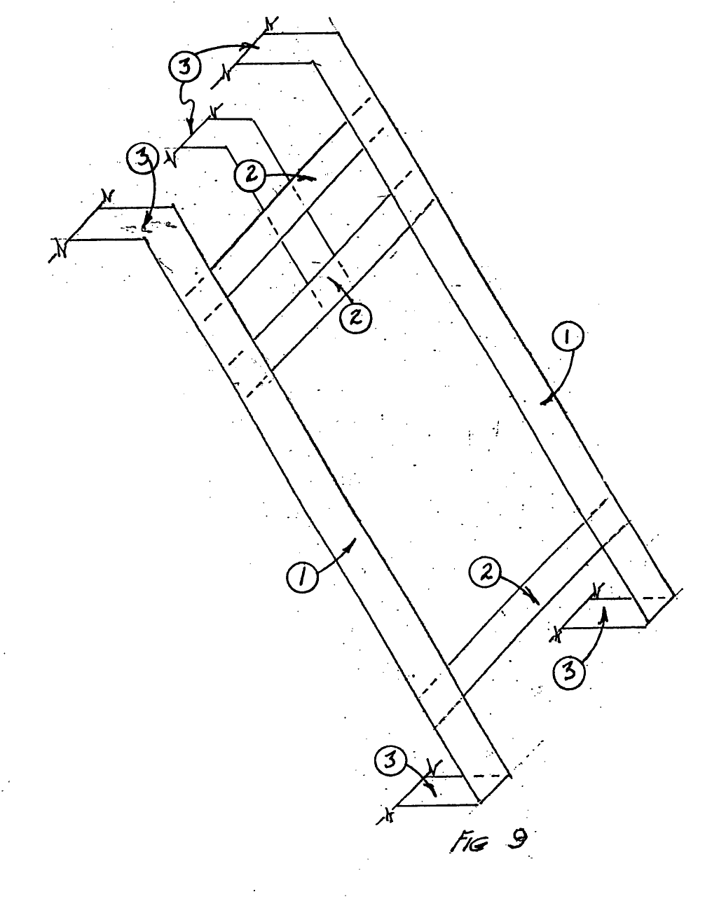

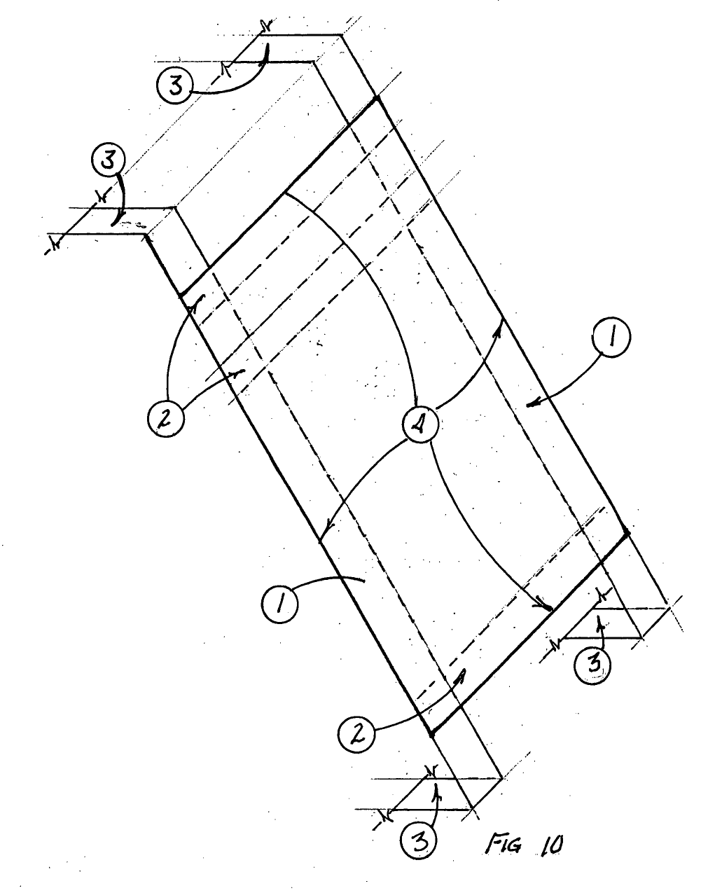

Referring to FIG. 2 (6) the padded buttocks and leg portion of the body support (FIG. 4) (4) affixed via stitching or other permanent means, to the two rearward latch tethers depicts the upper, rearward, vehicle attachment tethers/straps (9). FIG. 6 depicts the straps (9) affixed to the primary CHRS and the adjustment slots, for child sizes, in the buttocks, leg and head support (8), providing adjustment for lengthening the torso restraint strap and adjustment straps (7) added to the primary vehicle, attachment, tethers/straps (1).

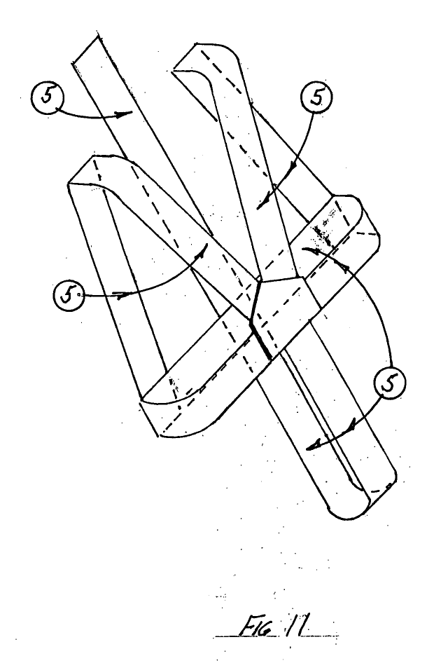

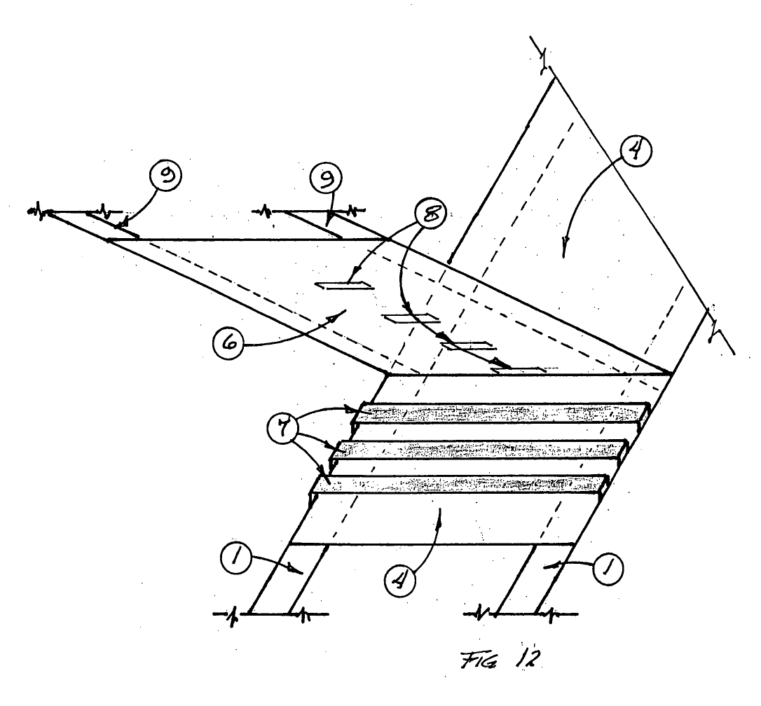

Referring to FIG. 7 and 7A further illustrates the various CHRS/RF components and its spanning capability and the accessibility and utilization of the vehicle seat back head rests or head rest posts for attaching the auxiliary tethers.

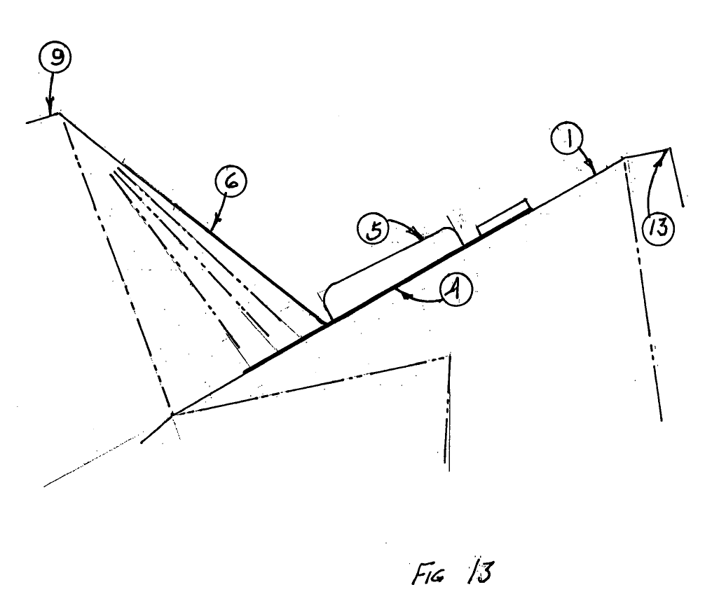

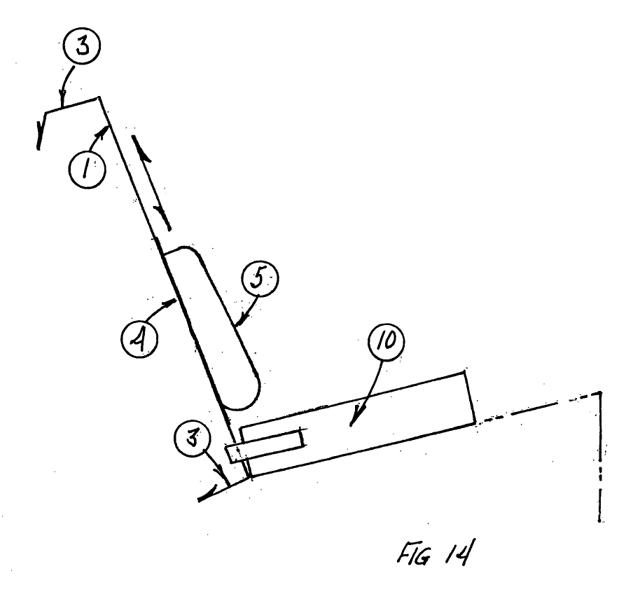

Referring to FIG. 8 and 8A illustrates the multiple vertical height capability of the CHRS/FF system for accommodating taller children utilizing the adjustable primary tether straps for attachment of the covered, foam, booster (10) to the primary straps (1) for additional needed child height.

Referring to FIG. 9 illustrates various auxiliary tether latch and head rest post adjustable attachments utilizing latch hooks and “O” rings (11), needed for numerous vehicle latch locations.

What is claimed is:

1-14. (canceled)

15. New A child's vehicular transportation, add-on, adjustable harness restraint, frontward and rearward facing system.
Dependent on claim 15. The add-on restraint system of claim 15, wherein its means utilizes a vehicle's manufacturer installed tether latches, seat and/or seat back frames, and/or a seat back head rest or rests and/or the head rest posts for installation or affixing the system to the vehicle.
Dependent on claim 15. The add-on restraint system of claim 15, wherein can be described and having the means to secure a child's body with a minimum of three restraints for the upper torso and pelvis.
Dependent on claim 15. The add-on restraint system of claim 15, wherein can be described as to fit all children sizes, weights, heights and ages required by NHTSA, Department of Transportation, 49CFR571.213 and CFR571.215.
Dependent on claim 15. The add-on restraint system of claim 15, wherein can be described as using an affixed, padded, reinforced flat or concave fabric body support with an adjustable, fabric leg and buttocks augmentation.
Dependent on claim 15. The add-on restraint system of claim 15, wherein, when installed in the rearward facing means in a vehicle, the adjustable/adaptable restraint system spans, traverses, the variable distance from the lower rear latch locations to the forward upper attachment connecting site or sites.
Dependent on claim 15. The add-on restraint system of claim 15, wherein the forward facing system means has available a multitude of vertical child restraint torso and pelvic positions, and adjusts to or conforms with the vehicles seat back, configurations, shape or form for improved securement of the system/child.
Dependent on claim 15. The add-on restraint system of claim 15, wherein the system means of using adjustable tethers, straps with latch hooks and/or “O” rings or other affixing hardware are employed, for ease of installation, to the various and numerous locations of the latches or other attachments.
Dependent on claim 15. The add-on restraint system of claim 15, wherein the system means provides the auxiliary tethers, straps to remain affixed/fastened to the vehicle, when the restraint system is removed, to prevent unsafe flailing of the tethers/straps and convenience for drivers, including seniors and handicapped individuals.
Dependent on claim 15. The add-on restraint system of claim 15, wherein includes a child's padded booster, for providing additional comfort and required height, attachable to the front facing mode.
